(19) United States
(12) Patent Application Publication
(10) Pub. No.: US 2025/0232184 A1
(43) Pub. Date: Jul. 17, 2025

(54) LANGUAGE MODEL TRAINING METHOD AND APPARATUS BASED ON CONTINUAL PRE-TRAINING

(71) Applicant: Alipay (Hangzhou) Information Technology Co., Ltd., Hangzhou, Zhejiang (CN)

(72) Inventors: Gangwei Jiang, Hangzhou (CN); Ying Wei, Hangzhou (CN); Caigao Jiang, Hangzhou (CN); Siqiao Xue, Hangzhou (CN); James Zhang, Hangzhou (CN); Hongyan Hao, Hangzhou (CN); Xiaoyun Feng, Hangzhou (CN); Yan Wang, Hangzhou (CN); Chen Pan, Hangzhou (CN); Jun Zhou, Hangzhou (CN)

(73) Assignee: Alipay (Hangzhou) Information Technology Co., Ltd., Hangzhou, Zhejiang (CN)

(21) Appl. No.: 19/017,071

(22) Filed: Jan. 10, 2025

(30) Foreign Application Priority Data
Jan. 11, 2024 (CN) 202410048420.0

(51) Int. Cl. G06N 3/094; G06N 3/0475

(52) U.S. Cl. CPC G06N 3/094; G06N 3/0475

(57) ABSTRACT

Embodiments of this specification provide language model training methods and apparatuses based on continual pre-training. In one example method, a soft prompt feature corresponding to each current training sample in a current domain is obtained. A latent feature corresponding to each piece of text data in the current domain is obtained. A cross-domain loss value is determined based on a difference between the obtained latent feature and a latent feature obtained based on an initial current language model in a previous domain. When a training termination condition for the current domain is not satisfied, model parameters are adjusted based on the cross-domain loss value. When a training termination condition for the current domain is satisfied, the model training process is repeated by continuing using a training sample set in a next domain, until a training termination condition for continual pre-training is satisfied.

### TECHNICAL FIELD

Embodiments of this specification generally relate to the field of computer technologies, and in particular, to language model training methods and apparatuses based on continual pre-training.

### BACKGROUND

Pre-trained language models generally refer to language models that are trained in an unsupervised manner based on large-scale corpora. By learning general features of languages, they have achieved breakthrough success in various natural language processing (NLP) tasks, such as text classification, information retrieval, named entity recognition, machine translation, and question answering systems. However, the pre-trained language models generally require a large amount of training data and have large parameter scales. When faced with new data, conventional learning methods need to retrain the models from scratch, which is expensive and cannot be effectively implemented. Therefore, how to enable the existing models to learn new data while ensuring generalization of the pre-trained language models without forgetting prior knowledge has become a problem that needs to be resolved.

### SUMMARY

In view of the above, embodiments of this specification provide language model training methods and apparatuses based on continual pre-training. A training effect of a pre-trained language model can be effectively improved by using the methods and apparatuses.

According to one aspect of embodiments of this specification, a language model training method based on continual pre-training is provided and includes: iteratively performing the following model training process by using a training sample set in a current domain, until a training termination condition for the current domain is satisfied, where each training sample in the training sample set includes text data: providing a textual latent feature corresponding to each piece of text data in a current training sample set in the current domain to a current soft prompt generation model to obtain a soft prompt feature corresponding to each current training sample; providing each piece of text data in the current training sample set and a corresponding soft prompt feature to a current language model to obtain a latent feature corresponding to each piece of text data in the current domain, where an initial current language model is obtained through training based on a training sample set in a previous domain; determining a cross-domain loss value based on a difference between the obtained latent feature corresponding to each piece of text data in the current domain and a corresponding latent feature that is obtained based on the initial current language model in the previous domain; in response to failure to satisfy the training termination condition for the current domain, adjusting model parameters of the current soft prompt generation model and the current language model based on the cross-domain loss value, where the soft prompt generation model and the language model after the model parameter adjustment serve as a current soft prompt generation model and a current language model for a next model training process; and in response to satisfaction of the training termination condition for the current domain, continuing using a training sample set in a next domain to repeat the model training process by using the training sample set in the domain, until a training termination condition for continual pre-training is satisfied.

According to another aspect of embodiments of this specification, a fine-tuning method for a language processing model is provided. The language processing model includes a fine-tuning soft prompt generation model, a fine-tuning language model, and a current predictive model, and the method includes: iteratively performing the following model fine-tuning process by using a fine-tuning training sample set, until a fine-tuning termination condition is satisfied, where each training sample in the fine-tuning training sample set includes text data and labeled data related to a fine-tuning task: providing a textual latent feature corresponding to each piece of text data in a current fine-tuning training sample set to a current fine-tuning soft prompt generation model to obtain a fine-tuning soft prompt feature corresponding to each current training sample; providing each piece of text data in the current fine-tuning training sample set and a corresponding fine-tuning soft prompt feature to a current fine-tuning language model to obtain a fine-tuning latent feature corresponding to each piece of text data, where an initial current fine-tuning soft prompt generation model and an initial current fine-tuning language model are obtained through training by using the above-mentioned language model training method; providing the fine-tuning latent feature corresponding to each piece of text data to a current predictive model related to the fine-tuning task to obtain a prediction result corresponding to each piece of text data; determining a predicted loss value of the current model fine-tuning process based on a difference between the prediction result corresponding to each piece of text data and the labeled data; and in response to failure to satisfy the fine-tuning termination condition, adjusting model parameters of the current fine-tuning language model and the current predictive model based on the predicted loss value, where the fine-tuning language model and the predictive model after the model parameter adjustment serve as a current fine-tuning language model and a current predictive model for a next model training process.

According to still another aspect of embodiments of this specification, a language model training apparatus based on continual pre-training is provided. The language model training apparatus is configured to use a training unit to iteratively perform a model training process by using a training sample set in a current domain, until a training termination condition for the current domain is satisfied, where each training sample in the training sample set includes text data, in a case of satisfaction of the training termination condition for the current domain, the training unit repeats the model training process by continuing using a training sample set in a next domain, until a training termination condition for continual pre-training is satisfied, and the training unit includes: a soft prompt generation module, configured to provide a textual latent feature corresponding to each piece of text data in a current training sample set in the current domain to a current soft prompt generation model to obtain a soft prompt feature corresponding to each current training sample; a latent feature generation module, configured to provide each piece of text data in the current training sample set and a corresponding soft prompt feature to a current language model to obtain a latent feature corresponding to each piece of text data in the current domain, where an initial current language model is obtained through training based on a training sample set in a previous domain; and a loss determining module, configured to determine a cross-domain loss value based on a difference between the obtained latent feature corresponding to each piece of text data in the current domain and a corresponding latent feature that is obtained based on the initial current language model in the previous domain; and the language model training apparatus further includes: a parameter adjustment unit, configured to adjust model parameters of the current soft prompt generation model and the current language model based on the cross-domain loss value in response to failure to satisfy the training termination condition for the current domain, where the soft prompt generation model and the language model after the model parameter adjustment serve as a current soft prompt generation model and a current language model for a next model training process.

According to yet another aspect of embodiments of this specification, a fine-tuning apparatus for a language processing model is provided. The language processing model includes a fine-tuning soft prompt generation model, a fine-tuning language model, and a current predictive model, and the fine-tuning apparatus is configured to use a training unit to iteratively perform a model fine-tuning process by using a fine-tuning training sample set, until a fine-tuning termination condition is satisfied, where each training sample in the fine-tuning training sample set includes text data and labeled data related to a fine-tuning task, and the training unit includes: a fine-tuning feature generation module, configured to provide a textual latent feature corresponding to each piece of text data in a current fine-tuning training sample set to a current fine-tuning soft prompt generation model to obtain a fine-tuning soft prompt feature corresponding to each current training sample; and provide each piece of text data in the current fine-tuning training sample set and a corresponding fine-tuning soft prompt feature to a current fine-tuning language model to obtain a fine-tuning latent feature corresponding to each piece of text data, where an initial current fine-tuning soft prompt generation model and an initial current fine-tuning language model are obtained through training by using the above-mentioned language model training method; and a predicted loss determining module, configured to provide the fine-tuning latent feature corresponding to each piece of text data to a current predictive model related to the fine-tuning task to obtain a prediction result corresponding to each piece of text data; and determine a predicted loss value of the current model fine-tuning process based on a difference between the prediction result corresponding to each piece of text data and the labeled data; and the fine-tuning apparatus further includes: a parameter fine-tuning unit, configured to adjust model parameters of the current fine-tuning language model and the current predictive model based on the predicted loss value in response to failure to satisfy the fine-tuning termination condition, where the fine-tuning language model and the predictive model after the model parameter adjustment serve as a current fine-tuning language model and a current predictive model for a next model training process.

According to another aspect of embodiments of this specification, a language model training apparatus based on continual pre-training is provided and includes at least one processor and a memory coupled to the at least one processor. The memory stores instructions. When the instructions are executed by the at least one processor, the at least one processor is enabled to perform the above-mentioned language model training method based on continual pre-training.

According to another aspect of embodiments of this specification, a fine-tuning apparatus for a language processing model is provided and includes at least one processor and a memory coupled to the at least one processor. The memory stores instructions. When the instructions are executed by the at least one processor, the at least one processor is enabled to perform the above-mentioned fine-tuning method for a language processing model.

According to another aspect of embodiments of this specification, a computer-readable storage medium is provided. The computer-readable storage medium stores a computer program. When the computer program is executed by a processor, the above-mentioned language model training method based on continual pre-training and/or the above-mentioned fine-tuning method for a language processing model are/is implemented.

According to another aspect of embodiments of this specification, a computer program product is provided and includes a computer program. The computer program is executed by a processor to implement the above-mentioned language model training method based on continual pre-training and/or the above-mentioned fine-tuning method for a language processing model.

### BRIEF DESCRIPTION OF DRAWINGS

The essence and advantages of the content of this specification can be further understood by referring to the following accompanying drawings. In the accompanying drawings, similar components or features can have the same reference numerals.

FIG. 1 is an example schematic diagram illustrating a continual pre-training method, according to some embodiments of this specification;

FIG. 2 illustrates an example architecture of a language model training method and apparatus based on continual pre-training, according to some embodiments of this specification;

FIG. 3 is an example flowchart illustrating a language model training method based on continual pre-training, according to some embodiments of this specification;

FIG. 4 is an example flowchart illustrating a process of generating a soft prompt feature, according to some embodiments of this specification;

FIG. 5 is an example schematic diagram illustrating a process of generating a weight vector, according to some embodiments of this specification;

FIG. 6 is an example schematic diagram illustrating a process of generating a cross-domain loss value, according to some embodiments of this specification;

FIG. 7 is another example schematic diagram illustrating a process of generating a cross-domain loss value, according to some embodiments of this specification;

FIG. 8 is an example flowchart illustrating a fine-tuning method for a language processing model, according to some embodiments of this specification;

FIG. 9 is an example block diagram illustrating a language model training apparatus based on continual pre-training, according to some embodiments of this specification;

FIG. 10 is an example block diagram illustrating a fine-tuning apparatus for a language processing model, according to some embodiments of this specification;

FIG. 11 is an example block diagram illustrating a language model training apparatus based on continual pre-training, according to some embodiments of this specification; and

FIG. 12 is an example block diagram illustrating a fine-tuning apparatus for a language processing model, according to some embodiments of this specification.

### DESCRIPTION OF EMBODIMENTS

The subject matter described here will be discussed below with reference to example implementations. It should be understood that these implementations are merely discussed to enable a person skilled in the art to better understand and implement the subject matter described in this specification, and are not intended to limit the protection scope, applicability, or examples described in the claims. Functions and arrangements of elements under discussion can be changed without departing from the protection scope of the embodiment content of this specification. Various processes or components can be omitted, replaced, or added in the examples as needed. In addition, features described for some examples can also be combined in other examples.

As used in this specification, the term “include” and its variant represent open terms, meaning “including but not limited to”. The term “based on” means “at least partially based on”. The terms “one embodiment” and “an embodiment” represent “at least one embodiment”. The term “another embodiment” represents “at least one other embodiment”. The terms “first”, “second”, etc. can refer to different or the same objects. Other definitions, whether explicit or implicit, can be included below. Unless explicitly stated in the context, the definition of a term is consistent throughout this specification.

In this specification, the term “continual pre-training” can refer to a training method. The training method efficiently updates a language model by sequentially pre-training the model based on a series of text data in a new domain, thereby eliminating costs of repeated training based on prior data.

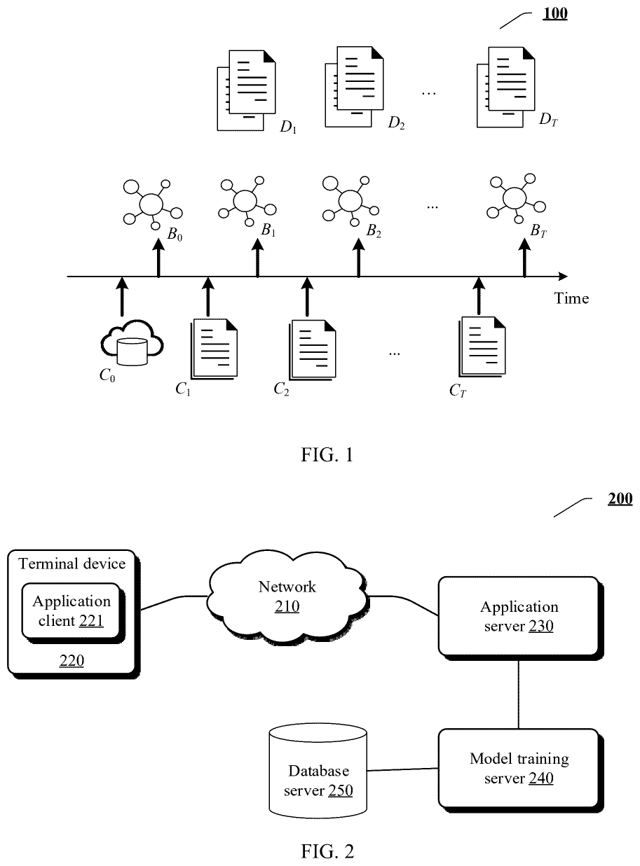

FIG. 1 is an example schematic diagram illustrating a continual pre-training method 100, according to some embodiments of this specification. As shown in FIG. 1, assume that a corpus is collected from T domains (such as the medical domain, the financial domain, and the news domain) in sequence to form a training sample set stream: {C₁, C₂, . . . , C_{T}}. An initial language model B⁰ can be obtained through training, for example, by using a general corpus C₀. Next, a training sample set C₁ in the first domain can be used to continue training on the basis of the initial language model B⁰ to obtain a language model B¹ that incorporates knowledge learned from the first domain. By analogy, a language model B^{T} that incorporates knowledge learned from the first domain to the T^{th} domain can be finally obtained. It can be understood that for the language model B^{t} at the t^{th} stage, in addition to using a labeled dataset in a current domain (for example, Dₜ) to test the current language model B^{t}'s ability to learn knowledge from the current domain, labeled datasets in learned domains (for example, Dₜ₋₁ and Dₜ₋₂) can also be used to test the current language model B^{t}'s ability to avoid forgetting. Labeled datasets in unlearned domains (for example, Dₜ₊₁ and Dₜ₊₂) can also be used to test a generalization ability of the current language model B^{t}.

Language model training methods and apparatuses based on continual pre-training according to embodiments of this specification are hereinafter described in detail with reference to the accompanying drawings.

FIG. 2 illustrates an example architecture 200 of a language model training method and apparatus based on continual pre-training, according to some embodiments of this specification.

In FIG. 2, a network 210 is used to interconnect a terminal device 220 and an application server 230.

The network 210 can be any type of network capable of interconnecting network entities. The network 210 can be a single network or a combination of various networks. In terms of coverage, the network 210 can be a local area network (LAN), a wide area network (WAN), etc. In terms of carrier media, the network 210 can be a wired network, a wireless network, etc. In terms of data switching technologies, the network 210 can be a circuit switched network, a packet switched network, etc.

The terminal device 220 can be any type of electronic computing device capable of connecting to the network 210, accessing a server or website on the network 210, processing data or signals, etc. For example, the terminal device 220 can be a desktop computer, a laptop computer, a tablet computer, a smartphone, etc. Although only one terminal device is shown in FIG. 2, it should be understood that a different quantity of terminal devices can be connected to the network 210.

In an implementation, the terminal device 220 can be used by a user. The terminal device 220 can include an application client device (for example, an application client device 221) that can provide the user with various services (for example, text classification, information retrieval, named entity recognition, machine translation, and question answering systems) based on natural language processing. In some cases, the application client device 221 can interact with the application server 230. For example, the application client device 221 can transmit a message input by the user to the application server 230 and receive, from the application server 230, a response associated with the message. However, it should be understood that, in other cases, the application client device 221 can also locally generate a response to the message input by the user instead of interacting with the application server 230. In this specification, the term “message” can refer to any input information, such as text data input by the user.

The application server 230 can store a trained language processing model. The language processing model can include a language model, a prompt generation model, and a predictive model. The application server 230 can be connected to a model training server 240. The model training server 240 can be configured to obtain the language model, the prompt generation model, and the predictive model through training based on a training sample set stored in a database server 250. In an example, the training sample set can include text data in various domains. In an example, the training sample set can include labeled data that matches a natural language processing task. As such, the application server 230 can provide corresponding services based on natural language processing. However, it should be understood that, in other cases, the application server 230 can also obtain the language model, the prompt generation model, and the predictive model through local training instead of interacting with the model training server 240.

It should be understood that all network entities shown in FIG. 2 are explanatory and any other network entities can be involved in the architecture 200 based on specific application needs.

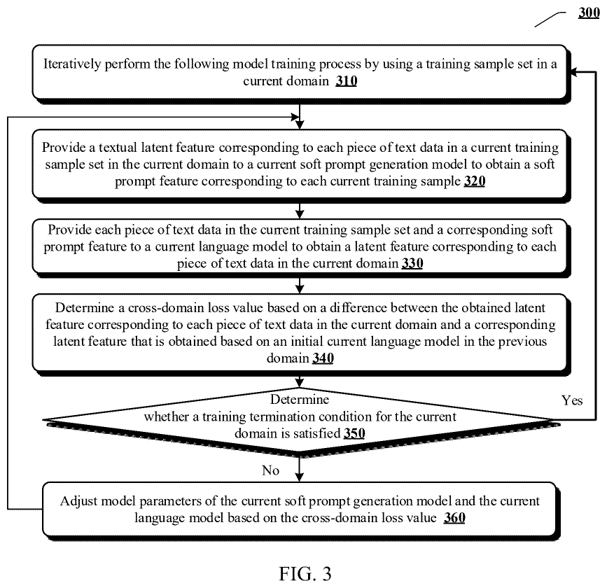

With continued reference to FIG. 3, FIG. 3 is an example flowchart illustrating a language model training method 300 based on continual pre-training, according to some embodiments of this specification. As shown in FIG. 3, in step 310, the following steps 320 to 350 are iteratively performed by using a training sample set in a current domain, until a training termination condition for the current domain is satisfied.

In the embodiments, each training sample in the training sample set can include text data. In an example, the text data included in each training sample in the training sample set in the current domain (which can be represented, for example, by Cᵢ) generally belong to the same domain (for example, an i^{th} domain), and the domain can be a sports domain, a financial domain, a digital domain, etc.

In step 320, a textual latent feature corresponding to each piece of text data in a current training sample set in the current domain is provided to a current soft prompt generation model to obtain a soft prompt feature corresponding to each current training sample.

In the embodiments, the soft prompt feature can be used to indicate learned cross-domain knowledge. The current training sample set can be selected based on the training sample set in the current domain. In an example, the current training sample set can refer to a batch of text data selected from the training sample set in the current domain in a current iteration process. A quantity of pieces of text data included in the current training sample set can be equivalent to a predetermined batch size. In an example, n training samples included in the current training sample set selected based on the training sample set in the current domain can be represented by [x¹, x², . . . , xⁿ].

In the embodiments, the textual latent feature can include a contextual feature of a text (contextual embedding), which can capture information about the entire text and the domain to which the text implicitly belongs. In an example, corresponding textual latent features can be obtained by using various pre-trained models that can be used for natural language processing (for example, transformer-based encoding layers, and long short-term memory networks). Optionally, model parameters of the above-mentioned model used to generate the textual latent features can also be adjusted during the model training process. The soft prompt generation model can include various models used for vector conversion, such as transformer-based encoding models. Model parameters of the current soft prompt generation model can be adjusted as the model training process progresses. In an example, a soft prompt feature corresponding to the i^{th} piece of text data can be expressed as Pⁱ=F(ĥ¹)=F(E(xⁱ)), where ĥⁱ can be used to represent a textual latent feature corresponding to the i^{th} piece of text data, E(•) and F(•) can be used to represent the model used to generate the textual latent feature and the current soft prompt generation model respectively.

Optionally, with continued reference to FIG. 4, FIG. 4 is an example flowchart illustrating a process 400 of generating a soft prompt feature, according to some embodiments of this specification.

In step 410, the textual latent feature corresponding to each piece of text data in the current training sample set in the current domain is provided to the current soft prompt generation model to obtain a weight vector corresponding to each current training sample.

In the embodiments, the soft prompt generation model can be used to indicate a mapping from the textual latent feature to the weight vector. In an example, the weight vector generally corresponds to a predetermined soft prompt feature component as a basis vector. For example, a weight vector α∈□^{M} can correspond to M predetermined soft prompt feature components, where each predetermined soft prompt feature component Vₘ∈□^{L×d}.

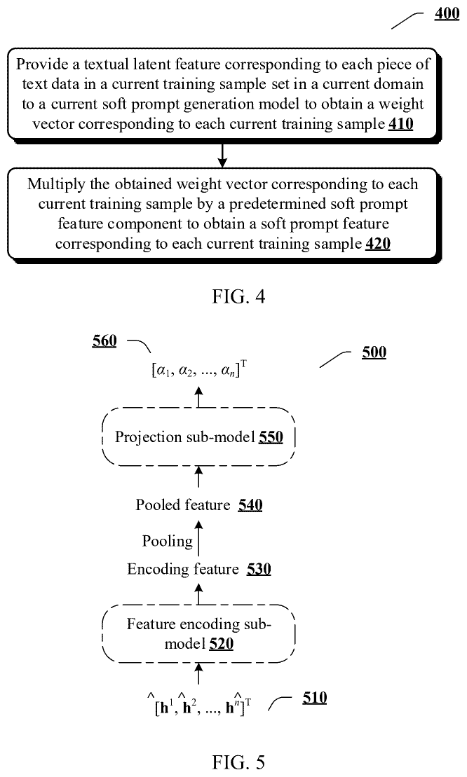

Optionally, with continued reference to FIG. 5, FIG. 5 is an example schematic diagram illustrating a process 500 of generating a weight vector, according to some embodiments of this specification.

As shown in FIG. 5, the current soft prompt generation model can include a current feature encoding sub-model and a current projection sub-model. In an example, the feature encoding sub-model can include a 6-layer transformer structure. A textual latent feature 510 corresponding to each piece of text data in the current training sample set in the current domain can be provided to a current feature encoding sub-model 520 to obtain an encoding feature 530 corresponding to each current training sample. Then the obtained encoding feature 530 corresponding to each current training sample is pooled to obtain a corresponding pooled feature 540. Then the pooled encoding feature corresponding to each current training sample is provided to a current projection sub-model 550 to obtain a weight vector 560 corresponding to each current training sample. It can be understood that model parameters of the feature encoding sub-model 520 and the projection sub-model 550 can be adjusted as the model training process progresses.

Based on this, this solution provides a specific implementation network for generating weight vectors, which is more suitable for learning weight vectors.

Back to FIG. 4, in step 420, the obtained weight vector corresponding to each current training sample is multiplied by a predetermined soft prompt feature component to obtain the soft prompt feature corresponding to each current training sample.

In an example, a soft prompt feature corresponding to a current training sample i can be expressed as Pⁱ=Σₘ₌₁^{M}αₘ·Vₘ, where αₘ can be used to represent a weight corresponding to the m^{th} predetermined soft prompt feature component Vₘ.

Based on this, this solution can synthesize final soft prompt features by generating weight vectors corresponding to the predetermined soft prompt feature components. Compared with directly generating soft prompt features, this solution can reduce the model parameters and alleviate forgetting by shifting from learning an entire feature representation to learning only the weight vectors.

Back to FIG. 3, in step 330, each piece of text data in the current training sample set and a corresponding soft prompt feature are provided to a current language model to obtain a latent feature corresponding to each piece of text data in the current domain.

In an example, a latent feature corresponding to text data xⁱ in the current domain can be expressed as hⁱ=Bⁱ(Pⁱ, eⁱ), where B^{t} can be used to represent the current language model, and eⁱ can be used to represent text encoding of text data xⁱ=[x₁ⁱ, x₂ⁱ, . . . , x_{T}ⁱ], where the text encoding is obtained through an embedding layer used for text vectorization, for example, eⁱ=[e₁ⁱ, e₂ⁱ, . . . , e_{T}ⁱ]. T in e_{T}ⁱ can be used to represent a quantity of tokens included in the text data. Usually, parameters of the embedding layer can be adjusted as the parameters of the current language model are adjusted. Optionally, the parameters of the embedding layer can also be obtained through pre-training. In an example, the text encoding and the soft prompt feature corresponding to the same text data can be combined and then provided to the current language model.

It is worthwhile to note that the continual pre-training method usually trains the language model based on knowledge from the first domain to the T^{th} domain in sequence. When the current training sample set is selected from a training sample set in the T^{th} domain for the first time, a corresponding current language model is an initial current language model. Model parameters of the initial current language model can be obtained through training based on a training sample set in a previous domain (that is, the (t−1)^{th} domain), for example, consistent with model parameters of a language model B^{t-1} trained by using the training sample set in the (t−1)^{th} domain.

In step 340, a cross-domain loss value is determined based on a difference between the obtained latent feature corresponding to each piece of text data in the current domain and a corresponding latent feature that is obtained based on the initial current language model in the previous domain.

In the embodiments, the cross-domain loss value can be used to indicate a degree of the difference between the obtained latent feature corresponding to each piece of text data in the current domain and the corresponding latent feature that is obtained based on the initial current language model in the previous domain. The latent feature can be obtained in the above-mentioned way.

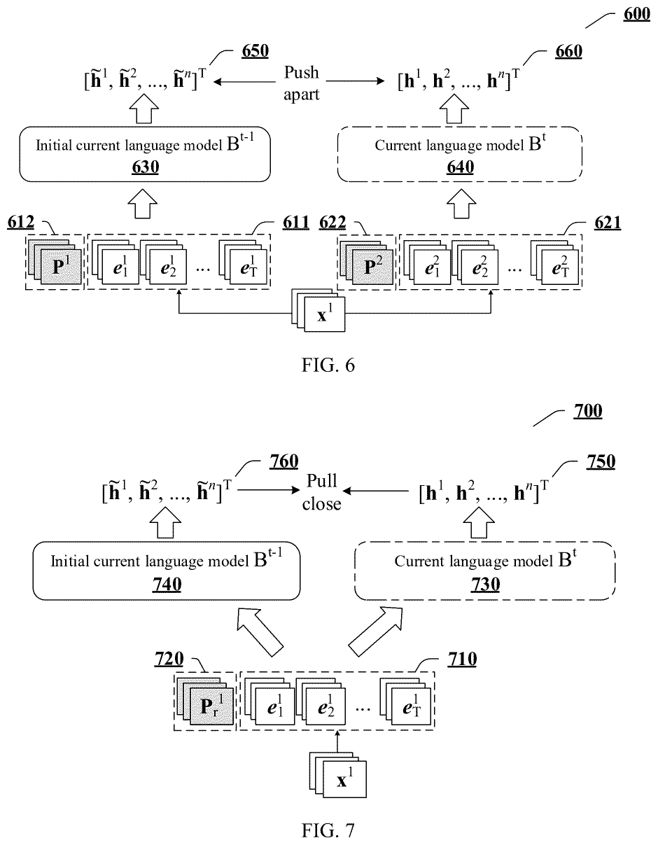

Optionally, with continued reference to FIG. 6, FIG. 6 is an example schematic diagram illustrating a process 600 of generating a cross-domain loss value, according to some embodiments of this specification.

As shown in FIG. 6, the latent feature corresponding each piece of text data and obtained based on the initial current language model in the previous domain can be obtained by providing each piece of text data in the current training sample set and a corresponding soft prompt feature in the previous domain to the initial current language model. The corresponding soft prompt feature in the previous domain can be obtained by providing the textual latent feature corresponding to each piece of text data in the current training sample set to a soft prompt generation model corresponding to the initial current language model. In an example, text encoding corresponding to text data x¹ can be shown in 611 and 621 in FIG. 6. It can be understood that when the parameters of the embedding layer are adjusted during the training process, 611 and 621 are usually different. When the parameters of the embedding layer are not adjusted during the training process, 611 and 621 are usually the same. A soft prompt feature P corresponding to the text data x¹ in the previous domain can be shown in 612 in FIG. 6, and can be obtained by using \tilde{P}¹=Fₜ₋₁(\tilde{h}¹)=Fₜ₋₁(E(x¹)). Fₜ₋₁(•) can be used to represent the soft prompt generation model corresponding to the initial current language model (that is, obtained through training in the previous domain). Similarly, a soft prompt feature P¹ corresponding to the text data x¹ in the current domain (as shown in 622 in FIG. 6) can be obtained with reference to the description of step 320. The initial current language model B^{t-1} (as shown in 630 in FIG. 6) and a current language model B^{t} (as shown in 640 in FIG. 6) are respectively used to obtain the latent feature corresponding to each piece of text data in the previous domain (as shown in 650 in FIG. 6) and the corresponding latent feature in the current domain (as shown in 660 in FIG. 6). Then a cross-domain adversarial loss value of the current model training process can be determined with an objective of maximizing a difference between the latent feature 650 and the latent feature 660. In an example, the cross-domain adversarial loss value can be expressed as L_{da}(x,W, Θ)=A(B^{t-1} (x, Fₜ₋₁(x)), B^{t}w (x, F_{Θ}(x))). W and Θ can be used to represent the model parameters of the current language model in the current domain and the corresponding current soft prompt generation model respectively. x can be used to represent each piece of text data in the current training sample set. A(•,•) can be used to represent a similarity matrix. For example, it can include an orthogonal constraint, a multilayer perceptron (MLP) based on a softmax function for calculating a similarity, and an opposite of KL divergence. In an example, Aₒᵣₜₕₒ(X, Y)=∥X•Y^{T}−I∥.

Based on this, this solution can push apart the hidden states of soft prompts in two successive domains by designing a minimum consistency metric, and train the language model including soft prompts to disagree with an output of the previous (for example, the previous domain) language model to the greatest extent. As such, richness of representations generated in each domain can be improved by using this adversarial loss.

Optionally, with continued reference to FIG. 7, FIG. 7 is another example schematic diagram illustrating a process 700 of generating a cross-domain loss value, according to some embodiments of this specification.

As shown in FIG. 7, each piece of text data in the current training sample set and a corresponding predetermined soft prompt feature can be provided to the current language model and the initial current language model respectively to obtain a predetermined prompt latent feature corresponding to each piece of text data in the current domain and a corresponding predetermined prompt latent feature in the previous domain respectively. In an example, text encoding [e₁¹, e₂¹, . . . e_{T}¹] corresponding to text data x¹ can be shown in 710 in FIG. 7. A corresponding predetermined soft prompt feature Pᵣ¹ can be shown in 720 in FIG. 7. The text encoding and the predetermined soft prompt feature corresponding to each piece of text data can be the same or different. Optionally, the predetermined soft prompt feature can be randomly generated. In an example, text encoding 710 and a predetermined soft prompt feature 720 corresponding to the text data x¹ can be provided to a current language model B^{t} (as shown in 730 in FIG. 7) and an initial current language model B^{t-1} (as shown in 740 in FIG. 7) respectively to obtain a predetermined prompt latent feature corresponding to each piece of text data in the current domain (as shown in 750 in FIG. 7) and a corresponding predetermined prompt latent feature in the previous domain (as shown in 760 in FIG. 7) respectively. Then a cross-domain alignment loss value of the current model training process can be determined with an objective of minimizing a difference between the obtained predetermined prompt latent feature 750 and predetermined prompt latent feature 760. In an example, the cross-domain alignment loss value can be expressed as Lₐ(x, W)=KL(B^{t-1} (x, Pᵣ)∥B^{t}w (x, Pᵣ)]. KL can be used to represent KL divergence. It can be understood that the KL divergence can also be replaced with another metric for measuring the degree of a difference between representation vectors. For meanings of other symbols, reference can be made to the above.

Based on this, this solution can simulate activation of a domain of existing knowledge in the language model by initializing a random prompt Pᵣ, and then enforce consistency under a plurality of random conditions by designing a cross-domain alignment loss, to reduce a distance between the latent features generated by the current language model B^{t} and the previous language model B^{t-1} based on the random prompt, thereby effectively preventing model forgetting. In addition, by maintaining a model capacity conditioned on other prompts, this solution retains plasticity of a new domain.

In step 350, it is determined whether the training termination condition for the current domain is satisfied.

In an example, whether the training termination condition is satisfied can be determined by determining whether the number of iterations reaches the predetermined number of iterations in the current domain, whether a training duration reaches a predetermined duration in the current domain, whether the loss value converges, etc.

If the determination is no, in step 360, model parameters of the current soft prompt generation model and the current language model are adjusted based on the cross-domain loss value.

In the embodiments, the soft prompt generation model and the language model after the model parameter adjustment can serve as a current soft prompt generation model and a current language model for a next model training process. Then a current training sample set in the current domain is redetermined by using the above-mentioned training sample set in the current domain, and steps 320 to 350 of the model training process are repeated, until the training termination condition for the current domain is satisfied.

Optionally, if the determination is no, the model parameters of the current soft prompt generation model and the current language model can be adjusted based on the cross-domain loss value and the cross-domain alignment loss value.

Optionally, the cross-domain loss value can also be combined with various other loss values suitable for language model training, such as a masked language modeling (MLM) loss commonly used for pre-training, and a predicted loss that is obtained based on a sample label as a desired output and can be used for various downstream tasks.

In an example, a total loss value can be expressed as L=Σᵢ₌₁^{N} [symbol] +λ₁· [symbol] +λ₂· [symbol] ·Lₘₗₘ can be used to represent the masked language modeling loss, and λ₁ and λ₂ can be used to represent predetermined weights. Based on this, this solution can adjust the model parameters of the current soft prompt generation model and the current language model with reference to the cross-domain loss value and the cross-domain alignment loss value, thereby further improving training effects of the models.

If the determination is yes, steps 310 to 360 of the model training process in the current domain are repeated by continuing using a training sample set in a next domain, until a training termination condition for continual pre-training is satisfied.

In the embodiments, the training termination condition for continual pre-training can be included in an example, and whether the training termination condition is satisfied can be determined by determining whether the number of iterations reaches the predetermined number of continual pre-training times, whether the training duration reaches a predetermined duration of continual pre-training, whether training sample sets in various domains have been used up, whether the loss value converges, etc.

The language model training method based on continual pre-training, disclosed in FIG. 1 to FIG. 7 can be used to enable the model to learn knowledge from a new domain in a continual learning process by adding domain-related soft prompt features. The method achieves a good effect, and an increase in a model parameter scale can be ignored. In addition, a cross-domain loss function designed based on a difference between corresponding latent features in adjacent domains provides sufficient generalization for the new domain.

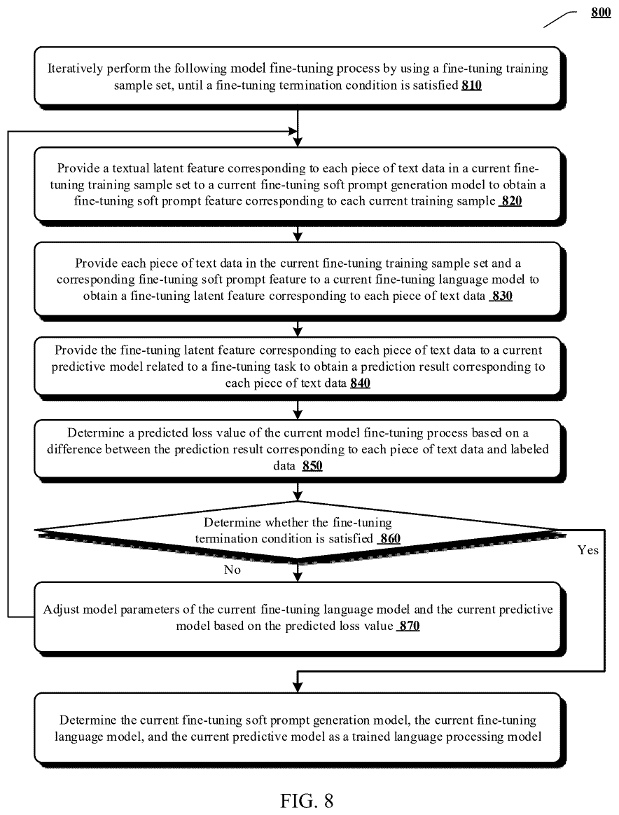

FIG. 8 is an example flowchart illustrating a fine-tuning method 800 for a language processing model, according to some embodiments of this specification.

As shown in FIG. 8, in step 810, the following steps 820 to 860 are iteratively performed by using a fine-tuning training sample set, until a fine-tuning termination condition is satisfied.

In the embodiments, each training sample in the fine-tuning training sample set can include text data and labeled data related to a fine-tuning task. The language processing model can include a fine-tuning soft prompt generation model, a fine-tuning language model, and a current predictive model. In an example, the fine-tuning task can include a text classification task, and the related labeled data can include a category to which the text belongs. In an example, the text data can include text pair data, the fine-tuning task can include a text semantic consistency determining task, and the related labeled data can be used to indicate whether semantics of a text pair are consistent.

In step 820, a textual latent feature corresponding to each piece of text data in a current fine-tuning training sample set is provided to a current fine-tuning soft prompt generation model to obtain a fine-tuning soft prompt feature corresponding to each current training sample.

In the embodiments, the current fine-tuning training sample set can be selected based on the above-mentioned fine-tuning training sample set. In an example, the current fine-tuning training sample set can refer to a batch of training samples selected from the above-mentioned fine-tuning training sample set in a current iteration process. A quantity of training samples included in the current fine-tuning training sample set can be equivalent to a predetermined batch size.

In step 830, each piece of text data in the current fine-tuning training sample set and a corresponding fine-tuning soft prompt feature are provided to a current fine-tuning language model to obtain a fine-tuning latent feature corresponding to each piece of text data.

In the embodiments, an initial current fine-tuning soft prompt generation model and an initial current fine-tuning language model can be obtained through training by using the above-mentioned language model training method described in FIG. 3 to FIG. 7. In an example, when the current fine-tuning training sample set is selected from the above-mentioned fine-tuning training sample set for the first time, the corresponding current fine-tuning soft prompt generation model and current fine-tuning language model are the initial current fine-tuning soft prompt generation model and the initial current fine-tuning language model.

In step 840, the fine-tuning latent feature corresponding to each piece of text data is provided to a current predictive model related to the fine-tuning task to obtain a prediction result corresponding to each piece of text data.

In the embodiments, the predictive model related to the fine-tuning task can include various machine learning models. In an example, the predictive model can include a text classification model, a text semantic consistency determining model, etc.

In step 850, a predicted loss value of the current model fine-tuning process is determined based on a difference between the prediction result corresponding to each piece of text data and the labeled data.

In the embodiments, the predicted loss value can be calculated based on a loss function suitable for supervised learning. In an example, the predicted loss value can be calculated by using cross-entropy.

In step 860, it is determined whether the fine-tuning termination condition is satisfied.

In an example, whether the training termination condition is satisfied can be determined by determining whether the number of fine-tuning times reaches the predetermined number of fine-tuning times, whether a training duration reaches a predetermined fine-tuning duration, whether the loss value converges, etc.

If the determination is no, in step 870, model parameters of the current fine-tuning language model and the current predictive model are adjusted based on the predicted loss value.

In the embodiments, the fine-tuning language model and the predictive model after the model parameter adjustment serve as a current fine-tuning language model and a current predictive model for a next model training process.

Optionally, if the determination is no, model parameters of the current fine-tuning soft prompt generation model, the current fine-tuning language model, and the current predictive model can be adjusted based on the predicted loss value. The fine-tuning soft prompt generation model, the fine-tuning language model, and the predictive model after the model parameter adjustment serve as a current fine-tuning soft prompt generation model, the current fine-tuning language model, and the current predictive model for the next model training process.

If the determination is yes, the current fine-tuning soft prompt generation model, the current fine-tuning language model, and the current predictive model can be determined as a trained language processing model. Therefore, a prediction result corresponding to an input text (such as a category to which the text belongs or a semantic consistency prediction result) can be obtained by using the fine-tuning soft prompt generation model, the fine-tuning language model, and the predictive model included in the trained language processing model.

On the basis of the above-mentioned language model training method based on continual pre-training, a method capable of fine-tuning is provided based on the above description. The method not only can further optimize the fine-tuning language model used to obtain textual latent features, but also can be combined with specific downstream fine-tuning tasks to implement corresponding text processing tasks.

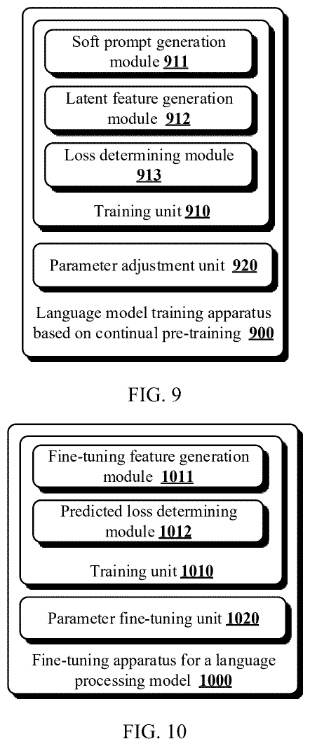

The following makes reference to FIG. 9. FIG. 9 is an example block diagram illustrating a language model training apparatus 900 based on continual pre-training, according to some embodiments of this specification. The apparatus embodiments may correspond to the method embodiments shown in FIG. 2 to FIG. 7, and the apparatus may be specifically applied to various electronic devices.

As shown in FIG. 9, the language model training apparatus 900 based on continual pre-training can be configured for a training unit 910 to iteratively perform a model training process by using a training sample set in a current domain, until a training termination condition for the current domain is satisfied. Each training sample in the training sample set can include text data. In a case of satisfaction of the training termination condition for the current domain, the training unit 910 repeats the model training process by continuing using a training sample set in a next domain, until a training termination condition for continual pre-training is satisfied. The training unit 910 can include a soft prompt generation module 911, a latent feature generation module 912, and a loss determining module 913.

The soft prompt generation module 911 is configured to provide a textual latent feature corresponding to each piece of text data in a current training sample set in the current domain to a current soft prompt generation model to obtain a soft prompt feature corresponding to each current training sample.

In an example, the soft prompt generation module 911 can be further configured to provide the textual latent feature corresponding to each piece of text data in the current training sample set in the current domain to the current soft prompt generation model to obtain a weight vector corresponding to each current training sample; and multiply the obtained weight vector corresponding to each current training sample by a predetermined soft prompt feature component to obtain the soft prompt feature corresponding to each current training sample.

In an example, the current soft prompt generation model includes a current feature encoding sub-model and a current projection sub-model. The soft prompt generation module 911 can be further configured to: provide the textual latent feature corresponding to each piece of text data in the current training sample set in the current domain to the current feature encoding sub-model to obtain an encoding feature corresponding to each current training sample; pool the obtained encoding feature corresponding to each current training sample to obtain a corresponding pooled feature; and provide the pooled encoding feature corresponding to each current training sample to the current projection sub-model to obtain the weight vector corresponding to each current training sample.

The latent feature generation module 912 is configured to provide each piece of text data in the current training sample set and a corresponding soft prompt feature to a current language model to obtain a latent feature corresponding to each piece of text data in the current domain, where an initial current language model is obtained through training based on a training sample set in a previous domain.

The loss determining module 913 is configured to determine a cross-domain loss value based on a difference between the obtained latent feature corresponding to each piece of text data in the current domain and a corresponding latent feature that is obtained based on the initial current language model in the previous domain.

In an example, the corresponding latent feature that is obtained based on the initial current language model in the previous domain is obtained by providing each piece of text data in the current training sample set and a corresponding soft prompt feature in the previous domain to the initial current language model, and the corresponding soft prompt feature in the previous domain is obtained by providing the textual latent feature corresponding to each piece of text data in the current training sample set to a soft prompt generation model corresponding to the initial current language model. The loss determining module 913 can be further configured to determine a cross-domain adversarial loss value with an objective of maximizing the difference between the obtained latent feature corresponding to each piece of text data in the current domain and the corresponding latent feature that is obtained based on the initial current language model in the previous domain.

In an example, the loss determining module 913 can be further configured to provide each piece of text data in the current training sample set and a corresponding predetermined soft prompt feature to the current language model and the initial current language model respectively to obtain a predetermined prompt latent feature corresponding to each piece of text data in the current domain and a corresponding predetermined prompt latent feature in the previous domain respectively; and determine a cross-domain alignment loss value of the current model training process with an objective of minimizing a difference between the obtained predetermined prompt latent feature corresponding to each piece of text data in the current domain and corresponding predetermined prompt latent feature in the previous domain.

The above-mentioned language model training apparatus 900 based on continual pre-training can further include a parameter adjustment unit 920, configured to adjust model parameters of the current soft prompt generation model and the current language model based on the cross-domain loss value in response to failure to satisfy the training termination condition for the current domain, where the soft prompt generation model and the language model after the model parameter adjustment serve as a current soft prompt generation model and a current language model for a next model training process.

In an example, the parameter adjustment unit 920 can be further configured to adjust the model parameters of the current soft prompt generation model and the current language model based on the cross-domain loss value and the cross-domain alignment loss value.

For specific operations of the soft prompt generation module 911, the latent feature generation module 912, and the loss determining module 913 included in the training unit 910, and the parameter adjustment unit 920, reference can be made to the detailed descriptions of the corresponding steps in the above-mentioned embodiments in FIG. 3 to FIG. 7. Details are omitted here for simplicity.

With continued reference to FIG. 10, FIG. 10 is an example block diagram illustrating a fine-tuning apparatus 1000 for a language processing model, according to some embodiments of this specification. The apparatus embodiments may correspond to the method embodiments shown in FIG. 8, and the apparatus may be specifically applied to various electronic devices. The language processing model can include a fine-tuning soft prompt generation model, a fine-tuning language model, and a current predictive model.

As shown in FIG. 10, the fine-tuning apparatus 1000 for a language processing model can be configured for a training unit 1010 to iteratively perform a model fine-tuning process by using a fine-tuning training sample set, until a fine-tuning termination condition is satisfied. Each training sample in the fine-tuning training sample set can include text data and labeled data related to a fine-tuning task. The training unit 1010 can include a fine-tuning feature generation module 1011 and a predicted loss determining module 1012.

The fine-tuning feature generation module 1011 is configured to provide a textual latent feature corresponding to each piece of text data in a current fine-tuning training sample set to a current fine-tuning soft prompt generation model to obtain a fine-tuning soft prompt feature corresponding to each current training sample; and provide each piece of text data in the current fine-tuning training sample set and a corresponding fine-tuning soft prompt feature to a current fine-tuning language model to obtain a fine-tuning latent feature corresponding to each piece of text data, where an initial current fine-tuning soft prompt generation model and an initial current fine-tuning language model are obtained through training by using the above-mentioned language model training method.

The predicted loss determining module 1012 is configured to provide the fine-tuning latent feature corresponding to each piece of text data to a current predictive model related to the fine-tuning task to obtain a prediction result corresponding to each piece of text data; and determine a predicted loss value of the current model fine-tuning process based on a difference between the prediction result corresponding to each piece of text data and the labeled data.

The above-mentioned fine-tuning apparatus 1000 for a language processing model can further include a parameter fine-tuning unit 1020, configured to adjust model parameters of the current fine-tuning language model and the current predictive model based on the predicted loss value in response to failure to satisfy the fine-tuning termination condition, where the fine-tuning language model and the predictive model after the model parameter adjustment serve as a current fine-tuning language model and a current predictive model for a next model training process.

In an example, the parameter fine-tuning unit 1020 can be further configured to adjust model parameters of the current fine-tuning soft prompt generation model, the current fine-tuning language model, and the current predictive model based on the predicted loss value, where the fine-tuning soft prompt generation model, the fine-tuning language model, and the predictive model after the model parameter adjustment serve as a current fine-tuning soft prompt generation model, the current fine-tuning language model, and the current predictive model for the next model training process.

For specific operations of the fine-tuning feature generation module 1011 and the predicted loss determining module 1012 included in the training unit 1010, and the parameter fine-tuning unit 1020, reference can be made to the detailed descriptions of the corresponding steps in the above-mentioned embodiments in FIG. 8. Details are omitted here for simplicity.

Embodiments of the language model training method and apparatus based on continual pre-training, and the fine-tuning method and apparatus for a language processing model according to embodiments of this specification have been described above with reference to FIG. 1 to FIG. 10.

The language model training apparatus based on continual pre-training, and the fine-tuning apparatus for a language processing model according to embodiments of this specification can be implemented by using hardware, or can be implemented by using software or a combination of hardware and software. Software implementation is used as an example. As a logical apparatus, the apparatus is formed by reading corresponding computer program instructions in a storage to a memory by a processor of a device in which the apparatus is located. In embodiments of this specification, for example, the language model training apparatus based on continual pre-training, and the fine-tuning apparatus for a language processing model can be implemented by using electronic devices.

FIG. 11 is a schematic diagram illustrating a language model training apparatus 1100 based on continual pre-training, according to some embodiments of this specification.

As shown in FIG. 11, the language model training apparatus 1100 based on continual pre-training can include at least one processor 1110, a storage (for example, a nonvolatile memory) 1120, a memory 1130, and a communication interface 1140. The at least one processor 1110, the storage 1120, the memory 1130, and the communication interface 1140 are connected together through a bus 1150. The at least one processor 1110 executes at least one computer-readable instruction (i.e., the above-mentioned elements implemented in a form of software) stored or encoded in the storage.

In an embodiment, computer-executable instructions are stored in the storage, and when the instructions are executed, the at least one processor 1110 is enabled to perform the above-mentioned language model training method based on continual pre-training.

It should be understood that, when the computer-executable instructions stored in the storage are executed, the at least one processor 1110 is enabled to perform the above-mentioned operations and functions described with reference to FIG. 1 to FIG. 8 in the embodiments of this specification.

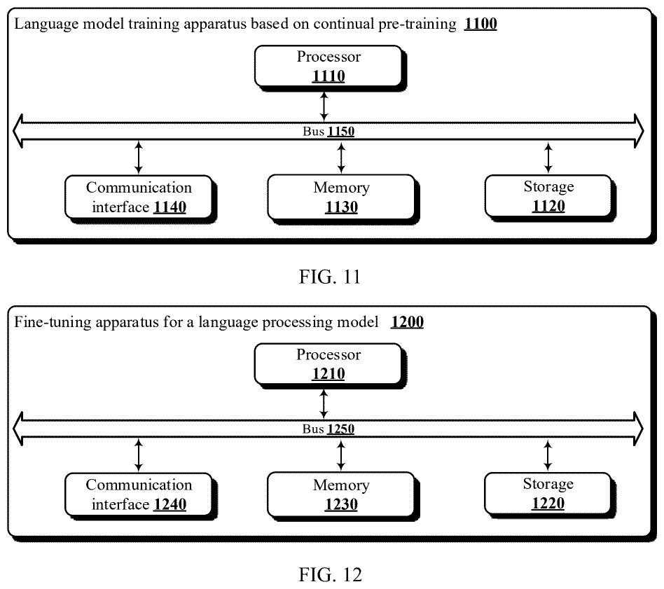

FIG. 12 is a schematic diagram illustrating a fine-tuning apparatus 1200 for a language processing model, according to some embodiments of this specification.

As shown in FIG. 12, the fine-tuning apparatus 1200 for a language processing model can include at least one processor 1210, a storage (for example, a nonvolatile memory) 1220, a memory 1230, and a communication interface 1240. The at least one processor 1210, the storage 1220, the memory 1230, and the communication interface 1240 are connected together through a bus 1250. The at least one processor 1210 executes at least one computer-readable instruction (i.e., the above-mentioned elements implemented in a form of software) stored or encoded in the storage.

In an embodiment, computer-executable instructions are stored in the storage, and when the instructions are executed, the at least one processor 1210 is enabled to perform the above-mentioned fine-tuning method for a language processing model.

It should be understood that, when the computer-executable instructions stored in the storage are executed, the at least one processor 1210 is enabled to perform the above-mentioned operations and functions described with reference to FIG. 8 in the embodiments of this specification.

According to one or more embodiments, a program product such as a computer-readable medium is provided. The computer-readable medium can have instructions (to be specific, the above-mentioned elements implemented in a form of software). When the instructions are executed by a computer, the computer is enabled to perform the above-mentioned operations and functions described with reference to FIG. 1 to FIG. 8 in the embodiments of this specification.

Specifically, a system or an apparatus equipped with a readable storage medium can be provided, and software program code for implementing the functions in any one of the above-mentioned embodiments is stored in the readable storage medium, so that a computer or a processor of the system or the apparatus reads and executes the instructions stored in the readable storage medium.

In this case, the program code read from the readable medium can implement the functions in any one of the above-mentioned embodiments, and therefore the machine-readable code and the readable storage medium storing the machine-readable code form a part of this application.

Computer program code needed for operations in each part of this specification can be compiled in any one or more programming languages, including an object-oriented programming language such as Java, Scala, Smalltalk, Eiffel, JADE, Emerald, C++, C#, VB, NET, and Python, a conventional programming language such as C language, Visual Basic 2003, Perl, COBOL 2002, PHP, and ABAP, a dynamic programming language such as Python, Ruby, and Groovy, or another programming language. The program code can be run on a user computer, or on a user computer as an independent software package, or partly on a user computer and partly on a remote computer, or completely on a remote computer or server. In the latter case, the remote computer can be connected to the user computer through any form of network, such as a local area network (LAN) or a wide area network (WAN), or connected to an external computer (for example, via the Internet), or in a cloud computing environment, or used as a service, such as software as a service (SaaS).

Embodiments of the readable storage medium include a floppy disk, a hard disk, a magneto-optical disk, an optical disc (for example, a CD-ROM, a CD-R, a CD-RW, a DVD-ROM, a DVD-RAM, and a DVD-RW), a magnetic tape, a nonvolatile memory card, and a ROM. Alternatively, the program code can be downloaded from a server computer or a cloud over a communication network.

Specific embodiments of this specification are described above. Other embodiments fall within the scope of the appended claims. In some cases, actions or steps described in the claims can be performed in an order different from that in the embodiments and desired results can still be achieved. In addition, processes described in the accompanying drawings do not necessarily need a specific order or a sequential order shown to achieve the desired results. In some implementations, multitasking and parallel processing are also feasible or may be advantageous.

Not all steps and units in the above-mentioned procedures and system structure diagrams are necessary. Some steps or units can be ignored based on actual needs. An execution order of the steps is not fixed, and can be determined based on needs. The apparatus structure described in the above-mentioned embodiments can be a physical structure or a logical structure. In other words, some units can be implemented by the same physical entity, or some units can be implemented by a plurality of physical entities, or can be implemented together by some components in a plurality of independent devices.

The term “example” used throughout this specification means “used as an example, an instance, or an illustration” and does not mean “preferred” or “advantageous” over other embodiments. Specific implementations include specific details for the purpose of providing an understanding of the described technologies. However, these technologies can be implemented without these specific details. In some examples, well-known structures and apparatuses are shown in block diagrams, to avoid difficulty in understanding the concepts of the described embodiments.

Optional implementations of the embodiments of this specification are described above with reference to the accompanying drawings. However, the embodiments of this specification are not limited to specific details in the above-mentioned implementations. Within the scope of the technical concept of the embodiments of this specification, multiple simple variations can be made to the technical solutions of the embodiments of this specification, and these simple variations are all within the protection scope of the embodiments of this specification.

The above descriptions of the content of this specification are provided to enable any person of ordinary skill in the art to implement or use the content of this specification. Various modifications to the content of this specification are clear to a person of ordinary skill in the art. In addition, the general principle defined in this specification can be applied to other variations without departing from the protection scope of the content of this specification. Therefore, the content of this specification is not limited to the examples and designs described here, but aligns with the broadest scope of principles and novelty features that conform to this disclosure.

1. A computer-implemented method for language model training based on continual pre-training, comprising:
iteratively performing a model training process by using a training sample set in a current domain, until a training termination condition for the current domain is satisfied, wherein each training sample in the training sample set comprises text data:
providing a textual latent feature corresponding to each piece of text data in a current training sample set in the current domain to a current soft prompt generation model to obtain a soft prompt feature corresponding to each current training sample;
providing each piece of text data in the current training sample set and a corresponding soft prompt feature to a current language model to obtain a latent feature corresponding to each piece of text data in the current domain, wherein an initial current language model is obtained through training based on a training sample set in a previous domain;
determining a cross-domain loss value based on a difference between the obtained latent feature corresponding to each piece of text data in the current domain and a corresponding latent feature that is obtained based on the initial current language model in the previous domain;
in response to failure to satisfy the training termination condition for the current domain, adjusting model parameters of the current soft prompt generation model and the current language model based on the cross-domain loss value, wherein the current soft prompt generation model and the current language model after model parameter adjustment serve as a current soft prompt generation model and a current language model for a next model training process; and
in response to satisfaction of the training termination condition for the current domain, continuing using a training sample set in a next domain to repeat the model training process by using the training sample set in the next domain, until a training termination condition for continual pre-training is satisfied.

2. The computer-implemented method according to claim 1, wherein the corresponding latent feature that is obtained based on the initial current language model in the previous domain is obtained by providing each piece of text data in the current training sample set and a corresponding soft prompt feature in the previous domain to the initial current language model, and the corresponding soft prompt feature in the previous domain is obtained by providing the textual latent feature corresponding to each piece of text data in the current training sample set to a soft prompt generation model corresponding to the initial current language model; and
the determining a cross-domain loss value based on a difference between the obtained latent feature corresponding to each piece of text data in the current domain and a corresponding latent feature that is obtained based on the initial current language model in the previous domain comprises:
determining a cross-domain adversarial loss value with an objective of maximizing the difference between the obtained latent feature corresponding to each piece of text data in the current domain and the corresponding latent feature that is obtained based on the initial current language model in the previous domain.

3. The computer-implemented method according to claim 2, wherein before the determining a cross-domain adversarial loss value, the model training process further comprises:
providing each piece of text data in the current training sample set and a corresponding predetermined soft prompt feature to the current language model and the initial current language model respectively to obtain a predetermined prompt latent feature corresponding to each piece of text data in the current domain and a corresponding predetermined prompt latent feature in the previous domain respectively; and
determining a cross-domain alignment loss value of the model training process with an objective of minimizing a difference between the obtained predetermined prompt latent feature corresponding to each piece of text data in the current domain and the corresponding predetermined prompt latent feature in the previous domain.

4. The computer-implemented method according to claim 3, wherein the adjusting model parameters of the current soft prompt generation model and the current language model based on the cross-domain loss value comprises:
adjusting the model parameters of the current soft prompt generation model and the current language model based on the cross-domain loss value and the cross-domain alignment loss value.

5. The computer-implemented method according to claim 1, wherein the providing a textual latent feature corresponding to each piece of text data in a current training sample set in the current domain to a current soft prompt generation model to obtain a soft prompt feature corresponding to each current training sample comprises:
providing the textual latent feature corresponding to each piece of text data in the current training sample set in the current domain to the current soft prompt generation model to obtain a weight vector corresponding to each current training sample; and
multiplying the obtained weight vector corresponding to each current training sample by a predetermined soft prompt feature component to obtain the soft prompt feature corresponding to each current training sample.

6. The computer-implemented method according to claim 5, wherein the current soft prompt generation model comprises a current feature encoding sub-model and a current projection sub-model; and
the providing the textual latent feature corresponding to each piece of text data in the current training sample set in the current domain to the current soft prompt generation model to obtain a weight vector corresponding to each current training sample comprises:
providing the textual latent feature corresponding to each piece of text data in the current training sample set in the current domain to the current feature encoding sub-model to obtain an encoding feature corresponding to each current training sample;
pooling the obtained encoding feature corresponding to each current training sample to obtain a corresponding pooled feature; and
providing the pooled encoding feature corresponding to each current training sample to the current projection sub-model to obtain the weight vector corresponding to each current training sample.

7. A computer-implemented method for fine-tuning a language processing model, wherein the language processing model comprises a fine-tuning soft prompt generation model, a fine-tuning language model, and a current predictive model, and the computer-implemented method comprises:
iteratively performing the following model fine-tuning process by using a fine-tuning training sample set, until a fine-tuning termination condition is satisfied, wherein each training sample in the fine-tuning training sample set comprises text data and labeled data related to a fine-tuning task:
providing a textual latent feature corresponding to each piece of text data in a current fine-tuning training sample set to a current fine-tuning soft prompt generation model to obtain a fine-tuning soft prompt feature corresponding to each current training sample;
providing each piece of text data in the current fine-tuning training sample set and a corresponding fine-tuning soft prompt feature to a current fine-tuning language model to obtain a fine-tuning latent feature corresponding to each piece of text data, wherein an initial current fine-tuning soft prompt generation model and an initial current fine-tuning language model;
providing the fine-tuning latent feature corresponding to each piece of text data to a current predictive model related to the fine-tuning task to obtain a prediction result corresponding to each piece of text data;
determining a predicted loss value of a current model fine-tuning process based on a difference between the prediction result corresponding to each piece of text data and the labeled data; and
in response to failure to satisfy the fine-tuning termination condition, adjusting model parameters of the current fine-tuning language model and the current predictive model based on the predicted loss value, wherein the current fine-tuning language model and the current predictive model after model parameter adjustment serve as a current fine-tuning language model and a current predictive model for a next model training process.

8. The computer-implemented method according to claim 7, wherein the adjusting model parameters of the current fine-tuning language model and the current predictive model based on the predicted loss value comprises:
adjusting model parameters of the current fine-tuning soft prompt generation model, the current fine-tuning language model, and the current predictive model based on the predicted loss value, wherein the fine-tuning soft prompt generation model, the fine-tuning language model, and the current predictive model after model parameter adjustment serve as a current fine-tuning soft prompt generation model, the current fine-tuning language model, and the current predictive model for the next model training process.

9. The computer-implemented method according to claim 7, wherein the initial current fine-tuning soft prompt generation model and the initial current fine-tuning language model are trained according to comprising:
iteratively performing the following model training process by using a training sample set in a current domain, until a training termination condition for the current domain is satisfied, wherein each training sample in the training sample set comprises text data:
providing a textual latent feature corresponding to each piece of text data in a current training sample set in the current domain to a current soft prompt generation model to obtain a soft prompt feature corresponding to each current training sample;
providing each piece of text data in the current training sample set and a corresponding soft prompt feature to a current language model to obtain a latent feature corresponding to each piece of text data in the current domain, wherein an initial current language model is obtained through training based on a training sample set in a previous domain;
determining a cross-domain loss value based on a difference between the obtained latent feature corresponding to each piece of text data in the current domain and a corresponding latent feature that is obtained based on the initial current language model in the previous domain;
in response to failure to satisfy the training termination condition for the current domain, adjusting model parameters of the current soft prompt generation model and the current language model based on the cross-domain loss value, wherein the current soft prompt generation model and the current language model after model parameter adjustment serve as a current soft prompt generation model and a current language model for a next model training process; and
in response to satisfaction of the training termination condition for the current domain, continuing using a training sample set in a next domain to repeat the model training process by using the training sample set in the next domain, until a training termination condition for continual pre-training is satisfied.

10. The computer-implemented method according to claim 9, wherein the corresponding latent feature that is obtained based on the initial current language model in the previous domain is obtained by providing each piece of text data in the current training sample set and a corresponding soft prompt feature in the previous domain to the initial current language model, and the corresponding soft prompt feature in the previous domain is obtained by providing the textual latent feature corresponding to each piece of text data in the current training sample set to a soft prompt generation model corresponding to the initial current language model; and
the determining a cross-domain loss value based on a difference between the obtained latent feature corresponding to each piece of text data in the current domain and a corresponding latent feature that is obtained based on the initial current language model in the previous domain comprises:
determining a cross-domain adversarial loss value with an objective of maximizing the difference between the obtained latent feature corresponding to each piece of text data in the current domain and the corresponding latent feature that is obtained based on the initial current language model in the previous domain.

11. The computer-implemented method according to claim 10, wherein before the determining a cross-domain adversarial loss value, the model training process further comprises:
providing each piece of text data in the current training sample set and a corresponding predetermined soft prompt feature to the current language model and the initial current language model respectively to obtain a predetermined prompt latent feature corresponding to each piece of text data in the current domain and a corresponding predetermined prompt latent feature in the previous domain respectively; and
determining a cross-domain alignment loss value of the model training process with an objective of minimizing a difference between the obtained predetermined prompt latent feature corresponding to each piece of text data in the current domain and the corresponding predetermined prompt latent feature in the previous domain.

12. The computer-implemented method according to claim 11, wherein the adjusting model parameters of the current soft prompt generation model and the current language model based on the cross-domain loss value comprises:
adjusting the model parameters of the current soft prompt generation model and the current language model based on the cross-domain loss value and the cross-domain alignment loss value.

13. An apparatus comprising:
one or more processors; and
one or more tangible, non-transitory, machine-readable media storing one or more instructions that, when executed by the one or more processors, perform operations comprising a language model training method comprising:
iteratively performing a model training process by using a training sample set in a current domain, until a training termination condition for the current domain is satisfied, wherein each training sample in the training sample set comprises text data:
providing a textual latent feature corresponding to each piece of text data in a current training sample set in the current domain to a current soft prompt generation model to obtain a soft prompt feature corresponding to each current training sample;
providing each piece of text data in the current training sample set and a corresponding soft prompt feature to a current language model to obtain a latent feature corresponding to each piece of text data in the current domain, wherein an initial current language model is obtained through training based on a training sample set in a previous domain;
determining a cross-domain loss value based on a difference between the obtained latent feature corresponding to each piece of text data in the current domain and a corresponding latent feature that is obtained based on the initial current language model in the previous domain;
in response to failure to satisfy the training termination condition for the current domain, adjusting model parameters of the current soft prompt generation model and the current language model based on the cross-domain loss value, wherein the current soft prompt generation model and the current language model after model parameter adjustment serve as a current soft prompt generation model and a current language model for a next model training process; and
in response to satisfaction of the training termination condition for the current domain, continuing using a training sample set in a next domain to repeat the model training process by using the training sample set in the next domain, until a training termination condition for continual pre-training is satisfied.

14. The apparatus according to claim 13, wherein the corresponding latent feature that is obtained based on the initial current language model in the previous domain is obtained by providing each piece of text data in the current training sample set and a corresponding soft prompt feature in the previous domain to the initial current language model, and the corresponding soft prompt feature in the previous domain is obtained by providing the textual latent feature corresponding to each piece of text data in the current training sample set to a soft prompt generation model corresponding to the initial current language model; and
the determining a cross-domain loss value based on a difference between the obtained latent feature corresponding to each piece of text data in the current domain and a corresponding latent feature that is obtained based on the initial current language model in the previous domain comprises:
determining a cross-domain adversarial loss value with an objective of maximizing the difference between the obtained latent feature corresponding to each piece of text data in the current domain and the corresponding latent feature that is obtained based on the initial current language model in the previous domain.

15. The apparatus according to claim 14, wherein before the determining a cross-domain adversarial loss value, the model training process further comprises:
providing each piece of text data in the current training sample set and a corresponding predetermined soft prompt feature to the current language model and the initial current language model respectively to obtain a predetermined prompt latent feature corresponding to each piece of text data in the current domain and a corresponding predetermined prompt latent feature in the previous domain respectively; and
determining a cross-domain alignment loss value of the model training process with an objective of minimizing a difference between the obtained predetermined prompt latent feature corresponding to each piece of text data in the current domain and the corresponding predetermined prompt latent feature in the previous domain.

16. The apparatus according to claim 15, wherein the adjusting model parameters of the current soft prompt generation model and the current language model based on the cross-domain loss value comprises:
adjusting the model parameters of the current soft prompt generation model and the current language model based on the cross-domain loss value and the cross-domain alignment loss value.

17. The apparatus according to claim 13, wherein the providing a textual latent feature corresponding to each piece of text data in a current training sample set in the current domain to a current soft prompt generation model to obtain a soft prompt feature corresponding to each current training sample comprises:
providing the textual latent feature corresponding to each piece of text data in the current training sample set in the current domain to the current soft prompt generation model to obtain a weight vector corresponding to each current training sample; and
multiplying the obtained weight vector corresponding to each current training sample by a predetermined soft prompt feature component to obtain the soft prompt feature corresponding to each current training sample.

18. The apparatus according to claim 17, wherein the current soft prompt generation model comprises a current feature encoding sub-model and a current projection sub-model; and
the providing the textual latent feature corresponding to each piece of text data in the current training sample set in the current domain to the current soft prompt generation model to obtain a weight vector corresponding to each current training sample comprises:
providing the textual latent feature corresponding to each piece of text data in the current training sample set in the current domain to the current feature encoding sub-model to obtain an encoding feature corresponding to each current training sample;
pooling the obtained encoding feature corresponding to each current training sample to obtain a corresponding pooled feature; and
providing the pooled encoding feature corresponding to each current training sample to the current projection sub-model to obtain the weight vector corresponding to each current training sample.

19. The apparatus according to claim 13, wherein the operations further comprise a fine-tuning method for a language processing model, wherein the language processing model comprises a fine-tuning soft prompt generation model, a fine-tuning language model, and a current predictive model, and the fine-tuning method comprises:
iteratively performing the following model fine-tuning process by using a fine-tuning training sample set, until a fine-tuning termination condition is satisfied, wherein each training sample in the fine-tuning training sample set comprises text data and labeled data related to a fine-tuning task:
providing a textual latent feature corresponding to each piece of text data in a current fine-tuning training sample set to a current fine-tuning soft prompt generation model to obtain a fine-tuning soft prompt feature corresponding to each current training sample;
providing each piece of text data in the current fine-tuning training sample set and a corresponding fine-tuning soft prompt feature to a current fine-tuning language model to obtain a fine-tuning latent feature corresponding to each piece of text data, wherein an initial current fine-tuning soft prompt generation model and an initial current fine-tuning language model are obtained through training by using the language model training method;
providing the fine-tuning latent feature corresponding to each piece of text data to a current predictive model related to the fine-tuning task to obtain a prediction result corresponding to each piece of text data;
determining a predicted loss value of a current model fine-tuning process based on a difference between the prediction result corresponding to each piece of text data and the labeled data; and
in response to failure to satisfy the fine-tuning termination condition, adjusting model parameters of the current fine-tuning language model and the current predictive model based on the predicted loss value, wherein the current fine-tuning language model and the current predictive model after model parameter adjustment serve as a current fine-tuning language model and a current predictive model for a next model training process.

20. The apparatus according to claim 19, wherein the adjusting model parameters of the current fine-tuning language model and the current predictive model based on the predicted loss value comprises:
adjusting model parameters of the current fine-tuning soft prompt generation model, the current fine-tuning language model, and the current predictive model based on the predicted loss value, wherein the fine-tuning soft prompt generation model, the fine-tuning language model, and the current predictive model after model parameter adjustment serve as a current fine-tuning soft prompt generation model, the current fine-tuning language model, and the current predictive model for the next model training process.
